(19) United States
(12) Patent Application Publication
(10) Pub. No.: US 2010/0174555 A1
(43) Pub. Date: Jul. 8, 2010

(54) System for automatic clinical pathway optimization

(76) Inventors: Klaus Abraham-Fuchs, Erlangen (DE); Karsten Hiltawsky, Schwerte (DE); Michael Maschke, Lonnerstadt (DE); Sebastian Schmidt, Weisendorf (DE); Gudrun Zahlmann, Neumarkt (DE)

Correspondence Address: HARNESS, DICKEY & PIERCE, P.L.C., P.O.BOX 8910, RESTON, VA, 20195, US

(21) Appl. No.: 12/318,648

(22) Filed: Jan. 5, 2009

(51) Int. Cl. G06Q 50/00; G06N 5/02; G06F 17/30

(52) U.S. Cl. 705/3; 705/2; 706/46; 706/52; 707/E17.044

(57) ABSTRACT

At least one embodiment of the present invention refers to a method, a system, a computer readable medium and/or a computer program product for optimizing a clinical pathway. The clinical pathway includes a sequence of actions. In at least one embodiment, he method aims at finding the best suitable and optimal following action for a respective action. There is provided a set of rules, patient information data and optimization criteria. After having received a symptom or an action there is deduced a set of possible following actions. After having deduced all possible following actions, these possible following actions are evaluated by the optimization criteria. After evaluation the optimal following action is suggested as a result.

### FIELD

At least one embodiment of the invention refers to the field of medical computer science and generally relates to a method and/or a system for optimizing a clinical pathway in the course of therapy or diagnosis.

### BACKGROUND

In clinical routine it can be observed that a patient who suffers from a specific symptom or a set of diverse symptoms usually will undergo a clinical pathway, comprising a set of clinical actions. The clinical actions might refer to general clinical decisions, to a diagnosis or to a subsequent therapy, which also might be initiated. A decision for the next clinical action within the clinical pathway is typically made by medical staff and is based on all available patient information at hand. It is important to mention that especially in the beginning of a clinical pathway it is often necessary to gather more information about the patient in order to be able to decide which next action should be initiated. Such actions for example comprise a manual examination, patient interviews, looking up of recently stored patient records or applying diagnostic procedures, for example in-vitro diagnostic tests or in-vivo diagnostics.

Until now the evaluation of all available patient information as well as the decision for a next clinical action within the clinical pathway depends on the skills and experience of the responsible medical staff.

In order to guarantee a certain level of quality, so-called clinical guidelines have been introduced to clinical routine, implementing clinical knowledge. However, the application of these guidelines is only guaranteed if the responsible person is aware of it and actively applies the guidelines. Further, the knowledge having been implemented in the clinical guidelines is generic, so that a specific case rarely can be handled with these guidelines.

Further, an evaluation of a specific action with respect to its quality (effectiveness, time consumption etc.) can only be made in a general context, i.e. in context of all the other actions within the clinical pathway. For example, if a patient comes to a physician with abdominal pain, it usually might be the best choice to initiate an abdominal examination, having in mind a possible appendicitis. However, this action (further examination with respect to an appendicitis) might not be the best choice, in case recent patient record data show that this patient already has underwent an appendectomy. With other words, the decision for an optimal next step strongly depends on the context situation and cannot be evaluated isolated form and independent of previous and following steps or actions to be taken.

In addition to that, the next action within a clinical pathway does very often not take into account the optimization of the overall clinical pathway, for example to get a diagnosis.

In clinical medicine, several computer implemented support systems do exist for assisting clinical staff in patient treatment.

US application US 2003/0074340 describes a system for checking treatment plans. The system checks suggested treatment plans for plausibility and takes into account underlying patient information. Therefore, this system might only be used in a later course of patient treatment.

The application US 2004/0267576 discloses a method for referencing data records which include therapeutic advice items. This method aims at the problem that especially long term therapies are not updated automatically if medical guidelines are subject to changes, which in turn could effect the therapeutic treatment.

Further, patent application US 2005/0004817 discloses a method for processing a data record comprising therapeutic advice items in the course of medical treatment. This publication refers to the association of therapeutic information to therapeutic advice items and, in general, refers to the processing of data records in the course of medical treatment.

Moreover, the patent application US 2007/0094050 discloses a method for linking sets of data comprising medical therapeutic indications. A set of data of a therapeutic indication is linked to an output, comprising successfulness information with respect to the specific therapeutic indication.

However, these systems do not assist a responsible person in finding the optimal clinical pathway in the present case, by applying different optimization criteria.

### SUMMARY

At least one embodiment of the present invention has been made in view of the current work practice in order to support medical clinical staff in finding an optimal clinical pathway, including a set of actions to be taken in the course of a patient's treatment.

Therefore, at least one embodiment of the present invention is directed to a computer implemented tool which optimizes the clinical diagnostic or therapeutic path and which makes suggestions of the best next diagnostic step or action, being based on previous diagnostic results, so that the clinical pathway could be shortened and so that the quality of the treatment could be increased. Further optimization criteria might refer to a decrease in costs.

Accordingly, at least one embodiment of the present invention relates to a method for optimizing a clinical pathway, comprising a sequence or a set of actions, wherein the method comprises:
Providing a set of rules for deducing at least one following action (to a previous action);
providing patient information data;
providing a set of optimizing criteria for optimizing the clinical pathway, wherein the optimizing criteria are pre-definable and might be integrated in the set of rules;
receiving a symptom or an action;
deducing a set of possible following actions within the clinical pathway for the received symptom or for the received action by applying at least one of the provided set of rules and/or by applying the patient information data;
evaluating the deduced set of following actions by applying the optimization criteria for deducing at least one optimal following action;
suggesting the optimal following action as a result.

In the following there is given a short explanation of terms to be used within this application.

The term “clinical pathway” refers to a set of actions in the course of a patient's treatment within a hospital or a clinic or another medical department. The actions within the clinical pathway might be executed as a sequence or in parallel. Also, some of the actions might be executed with an overlap. Also, some actions might depend on previous actions and/or on the results of previous actions and/or on future action, which are already scheduled in the clinical pathway. Further, the result of an action might be fed back to the system as input, so that the system is able to learn. A typical clinical pathway could for example be: “Admitting a patient”, “Interviewing the patient”, “Ordering a laboratory examination for the patient”, “Reviewing the results of the lab”, “Generating a diagnosis for the patient”, “Generating a treatment plan for the patient's disease”.

This clinical pathway might be optimized according to several different optimization criteria. It is essential to mention that these optimization criteria might change over time, so that the optimization is dynamically adaptable. The optimizing criteria might be selected from: availability aspects, cost aspects, helpfulness aspects, overall-costs aspects, guideline suggestions, efficiency aspects, time aspects, particularly clinical pathway shortening aspects and a combination thereof. For example it is quite often that a decision suggests to have a computer tomography as next clinical action to be taken for the diagnostic treatment of the patient. However, the hospital only has one computer tomograph device. For this reason, possibly, another action would be more efficient, in case the computer tomograph is not available. For example, the patient could be interviewed in the time period the computer tomograph is not available. Afterwards, the computer tomography can be executed. Another example of an optimizing criteria are the cost related criteria. For example if a very cost intensive next clinical action would be suggested and the same result of this action is deducible also by other means, it makes no sense to initiate those cost-intensive evaluations. In this case an optimizing strategy would be to postpone this cost intensive evaluation until all other possibilities for having the clinical question answered by other means are evaluated.

According to one aspect of at least one embodiment of the present invention there are provided a set of rules for deducing at least one following action. Preferably, the rules are stored in a rule database and represent general medical knowledge. For example one rule could be: “If sex is male→abdominal pain could not indicate pregnancy”. These rules are dynamically adaptable according to knowledge and research. Further, the rules might be specified for particular use cases. The rules might be applied for excluding some actions or following actions in the course of diagnosis or therapy. Usually one action may have a set of following actions. These following actions might be evaluated according to statistical values or according to the rules or according to other parameters in order to assign a likelihood for the respective action.

According to another aspect of at least one embodiment there is provided patient information data. This data refers to meta data in relation to the patient. For example, patient information data might comprise: sex, weight, previous medication, previous examinations, actual and historical anamnesis data, insurance data of the patient, etc. Also this kind of information might be used for deducing a following action for the respective action and/or for evaluating the suggestion for an optimal following action.

Usually the method starts by receiving a respective symptom or by receiving an initial or a previous action. The symptom might be a medical symptom like fever, headache, abdominal pain etc. The term “action” refers to any step within the clinical pathflow and might be related to measuring data, ordering laboratory results, results from patient interview. An action might be divided into sub-actions and assigned to super-actions. Thus, the clinical pathway usually is structured hierarchically. Further, an action might be related to medical diagnosis and/or medical therapy.

It is possible to represent a clinical pathway by means of a diagnostic decision tree. The tree has one starting node which represents a symptom and wherein every node in the tree is a diagnostic test and wherein the leaf nodes of the tree are possible diagnosis. An edge of the tree represents possible results for the test of the respective node.

According to one aspect of at least one embodiment of the present invention a likelihood can be assigned to every edge, so that all suggested following actions might be evaluated according to their likelihood or according to other statistical values. Missing likelihoods may be estimated (e.g. as evenly distributed) or back-calculated from the likelihoods of more downwards nodes, for example incidents data for the respective disease. Also, every node might be assigned one or more cost values, which can be financial costs or other parameters, like time related parameters etc.

The system then calculates for every possible next action that can be carried out under the current circumstances and calculates—as a result—the optimal following action; the method might be executed repeatedly so that it recommences again for the second or further levels within the decision tree. The method will provide a solution that gives the biggest reduction in complexity of the decision tree and the lowest possible costs. Depending on a model it is also possible that different ways may lead to the same diagnosis. Then, the decision tree will be a decision graph.

However, all the aspects which have been mentioned with respect to the decision tree also might be applied to the decision graph. According to an example embodiment of the present invention this decision tree or decision graph might be represented for each clinical pathway, so that a user might get an overview of the actions and possible following actions and possibly also of those actions which are excluded from further treatment.

Generally, the clinical pathway might be related to a diagnostic process or to a therapeutic process or to a combination thereof. Further, also other processes within the clinical treatment might be applied.

According to one aspect of at least one embodiment of the present invention the medical staff is automatically supported during clinical decision taking process. The decision taking process might be related to diagnosis and/or therapy within a clinical pathway. This clinical pathway is optimized by suggesting at least one optimal following action. This optimal following action might be a single action or might be a set of actions.

The result of the computer implemented method according to at least one embodiment of the invention is such a suggestion for an optimal following action. It has to be mentioned that the method according to at least one embodiment of the invention might be applied within every phase of the clinical pathway. This means that the method according to at least one embodiment of the invention might be applied for the initial step after having received a symptom of the patient or also might be applied for deducing a diagnosis at the end of a diagnostic pathway. Further, the method also might be applied for every step within the clinical pathway. Moreover, the steps of the method might be executed in another order.

According to yet another aspect of at least one embodiment of the present invention will be implemented as information technological based expert system with a user interface to the medical staff. The expert system according to at least one embodiment of the invention is adapted to extract patient information from electronic health records as well as to ask the user (medical staff) for further information about the patient. Further, it is possible to extract information from internet based data bases of from information provider. For example, it is possible that there is provided a pre-defined set of questions which can be activated based on the previous diagnostic results. These questions might then be answered by the user by user interaction. In turn, the system then suggests possible next clinical steps to take and optimizes these suggestions according to the pre-defined optimization criteria, as mentioned above.

According to another aspect of at least one embodiment of the present invention the result of this method is tracked, so that it might be used for further clinical optimization processes in future.

According to another aspect of at least one embodiment of the present invention the deducing of a set of possible following actions and/or the evaluating of the deduced set of following actions might be based on the same or on different criteria. Deducing and/or evaluating might be done according to all available patient information, according to a selection of patient information, according to optimization criteria and/or according to an underlying database. Additionally, also user information might be usable for these steps. For example the evaluating might be executed so that a diagnosis might be generated as efficient as possible. Furthermore, the optimization criteria might relate to quality aspects as well as to statistical aspects.

One advantage of at least one embodiment of the present invention is to be seen in that decision for a next clinical action within the clinical pathway will take into account the optimization of the clinical pathway as a whole (for example all anamnestic information will be explored or more blood tests will be done before a MR procedure is to be initiated, because the MR procedure is very cost intensive and possibly could be avoided due to other information gathered by “cheaper” means). Each single decision will be based on more information and might, for example, include cost efficiency aspects. According to at least one embodiment of the present invention a quality standard of care can be ensured with fewer mistakes to happen.

At least one embodiment of the present invention further refers to a computer implemented system for optimizing a clinical pathway by means of an overall approach, comprising optimization criteria. The system comprises a reception unit, a deduction unit, an evaluation unit and a result unit.

The reception unit is adapted to receive a symptom or an initial action.

The deduction unit is adapted for deducing a set of possible following actions within the clinical pathway for the received symptom or for the received initial action by applying at least one of the provided rules and/or by applying patient information data. The rules and/or the patient information data might be accessed directly, in case rule data and/or patient information data are stored in the deduction unit itself or might be accessed indirectly, in case rule data and/or patient information data are stored separately from the deduction unit, for example in distinct databases. In the latter case these data might be accessed by a link.

The evaluation unit is adapted for evaluating the deduced following action(s) by applying the optimization criteria for deducing at least one optimal following action. In case the optimization criteria are implemented in the rules, the rules might be accessed repeatedly. The optimization criteria and/or the rules are dynamically adaptable.

The result unit is adapted for suggesting the optimal following action as a result. Preferably, the result unit has a graphical user interface for representing the decision tree or for input and/or output actions.

According to another aspect of at least one embodiment of the present invention the result comprises a set of following actions.

According to get another aspect of at least one embodiment of the present invention the result is provided or is transformed in a machine-readable format and could be forwarded to other computer implemented modules. This aspect has the advantage that a method could be automated as much as possible.

Alternative embodiments are explained in the detailed description of the drawings. For example the system might also comprise a rule database and/or a patient information database and/or an optimization database. Further, the system might be integrated in a more complex clinical workflow system.

At least one embodiment of the invention also refers to a computer program product which implements the above described method. The product might be stored on a computer readable medium.

### BRIEF DESCRIPTION OF THE DRAWINGS

FIG. 1 shows an overview of the system of the present invention according to an example embodiment.

FIG. 2 shows an example of a decision tree which might be used or which might be outputted according to an example embodiment of the present invention.

FIG. 3 shows a flowchart according to an example embodiment of the present invention.

### DETAILED DESCRIPTION OF THE EXAMPLE EMBODIMENTS

The following description of illustrated example embodiments of the invention is not intended to be exhaustive or to limit the invention to precise form disclosed. Specific embodiments of and examples for the invention are described herein for illustrative purposes, whereas equivalent modifications are possible within the scope of the invention and can be made without deviating from the scope of the invention.

For example, to some extend the description is based on optimizing a clinical pathway. However, alternatively, also other pathways could be optimized according to the present invention, for example pathways in the field of industrial production or clinic management, clinic rescores management or the like.

Further, the method might be implemented in software, in coded form to be used in connection with a computer. Alternatively, it is possible to implement the method according to the invention in hardware or separate hardware modules. The hardware modules are than adapted to perform the functionality of this steps of the method described herein. Furthermore, it is possible to have a combination of hardware and software modules.

Particularly, an embodiment of the present invention relates to a computer-implemented approach for optimizing a clinical pathway, based on optimization criteria, which might be defined in a prephase. A general aim of an embodiment of the present invention is to be seen in providing a holistic approach for an optimization of a clinical pathway, which means, that each single action or step within the clinical pathway is optimized according to the overall clinical pathway. With other words each clinical action is going to be optimized within the context of the whole clinical pathway and is not evaluated in isolation.

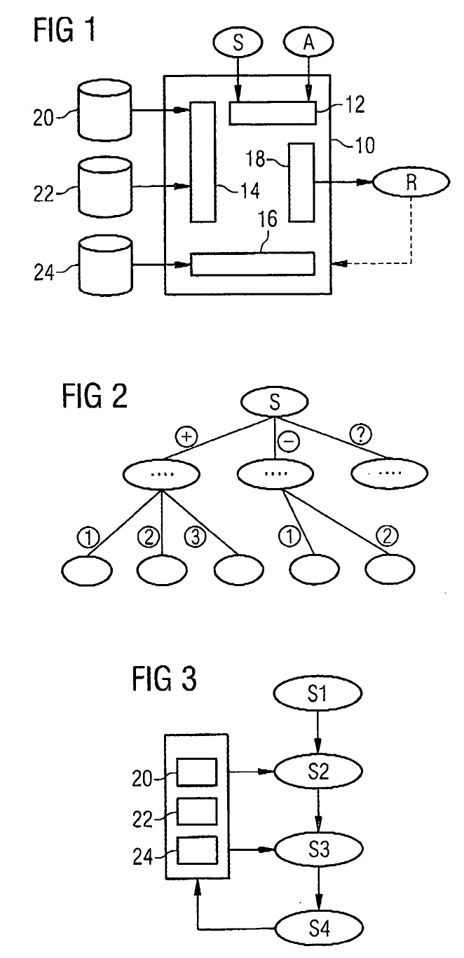

With respects to FIG. 1 a general overview of a system according to an example embodiment of the invention is shown. A system 10 comprises a reception unit 12, a deduction unit 14, an evaluation unit 16 and a result unit 18. In alternative embodiments also other units might be incorporated to a system 10.

The reception unit 12 of the system 10 is adapted to receive a symptom S or an action A of a patient.

For the symptom S or for the action A a following action should be deduced, which should be optimized within the context of the whole clinical pathflow in which the patient with symptom S and/or the action A is part of. As can be seen in FIG. 1 the system 10 in linked to a rule database 20, to a patient information database 22 and to an optimization criteria database 24. However, in an alternative embodiment it is also possible to incorporate the optimization criteria into the rule database 20, so that no separate optimization module 24 is necessary anymore. Additionally, a cost-related database is accessible and might be used.

The result unit 18 is adapted to provide a result R. The result usually is a suggestion for an optimal following action for the action A which has been received by the reception unit 12. Also the result R might comprise a second suggestion as second optimal following action for the action A. Also, the result R might comprise a decision tree with all possible following actions and with the evaluation for each following action. Preferably, this will be represented by a decision tree. Further details with respect to the decision tree will be explained below/and with respect to the explanation of FIG. 2.

In an example embodiment, the result R is fed back to the system 10 so that the system 10 able to learn. This is represented in FIG. 1 by the doted arrow starting from the circle, which represents the result R and pointing to the system 10. Accordingly, the system 10 is a self learning expert system.

One further advantage of an example embodiment of the present invention is to be seen in that for the evaluation of the next optimal following action all relevant information is acquired or is accessed. Relevant information might be seen in the acquisition of further patient information, meta information with respect to the patient's treatment, resource planning data, cost related data and all optimization criteria which might be applied.

Particularly, the optimization criteria might be adapted to implement a most efficient pathflow so that a diagnosis might be generated as fast and efficient as possible. Another possibility is to adopt optimization criteria with respect to the costs. Particularly, it is possible to look for a pathway which is optimized with respect to the costs. In this case all possible following actions will be evaluated according to the costs they incure. For example, accessing the patient information data 22 will be less cost intensive as a blood test or as an image acquisition process, like a CT. In this respect a cost—optimized suggestion would be to have another patient interview and not to initiate a cost intensive imaging process. Another option is to optimize the pathflow according to time aspects, e.g. to get a shortest time pathflow.

As already mentioned, the optimization criteria are dynamically adaptable, in order to adapt the method according to the invention to specific use cases. Particularly, it is possible to have a combination of several optimization criteria.

Moreover the optimization criteria might relate to financial costs, to resource planning information, particularly to availability of clinical resources, to probability of the following actions which have the highest probability to be applied according to previous evaluations etc.

Probability aspects refer to likelihoods which will be assigned to each possible following action. For example, if a patient has pain in the left breast possible following actions will be:
A further patient's interview,
examination of the heart or
manual examination of the patient's breast.

However, the highest probability will be assigned to the examination of the heart, in order to exclude a heart attack as possible diagnosis. Additionally, the database for patient information date 22 might be accessed in order to get further details with respect to previous heart diseases of the patient.

There are various diagnosis according to international classification of diseases (ICD), which can be assigned to a patient with a specific symptom or with a set of symptoms. Starting from this symptom S a following sequence of clinical actions will be made and might be represented by a decision tree, which will finally end up in a set of diagnosis and/or therapies. The suggested system will basically cut down this decision tree according to all available and all relevant information, particularly with respect to patient information data 22, optimization criteria 24, rules 20, meta information with respect to the patient and clinic—related information.

As a example FIG. 2 represents such a decision tree. The root of the tree represents a symptom S, an initial action A or any action within the clinical pathflow. As a node of the tree represents a clinic decision, for example a diagnostic test, a question to the patient, a blood test, an imagine acquisition etc. The edges of the tree represent respective results of these tests/decisions (represented by the nodes of the tree). The leaf nodes of the tree represent possible diagnoses. In FIG. 2 the decision tree comprises three levels.

In this case the symptom S (represented in the root node) has three possible following actions. The first one is evaluated with “+”, the second one is evaluated by a “−” and the third one might not be evaluated completely for that time, so that it is evaluated with “?”. The first and the second following action again comprise following actions. This refers to the fact that the present method could be applied iteratively for each action within the clinical pathway. Thus, the action A for which a following action is searched needs necessarily not to be the initial symptom S. Also any other action A within the clinical pathway might be applied in order to search the best following action for this action A.

As the decision for a next or following optimal action the decision taking, as been represented in FIG. 2, is hierarchical. Thus, there are decisions which might be used repeatedly also for other pathways or for other decisions for optimal following actions. This is why, in a preferred embodiment, the result R is fed back to the system. With this aspect the rule 20 might be adapted to incorporate knew knowledge which has been acquired.

In an alternative embodiment the optimizing criteria 24 might be implemented in rules 20 or in a respective database for rules 20. Then, no optimizing criteria 24 and no separate database for storing optimizing criteria 24 is necessary anymore. Evaluating is only based on rules 20, also incorporating optimizing criteria 24.

The system 10 additionally comprises a user interface, which is adapted to represent this decision tree, so that a clinical user will get an overview of the best solution to be taken most efficiently.

According to one aspect of an embodiment of the present invention it is possible that only a selection of this decision tree will be represented as output. Further, it is possible to highlight a selection of nodes of the decision tree, which are relevant for the optimal pathway, whereas other (irrelevant) nodes are represented as background information.

With respect to FIG. 3 a possible optimization process is explained in more detail.

In a first step at S1 the symptom S or the action A is received. Usually this is done by the reception unit 12 of the system 10.

According to an example embodiment deducing the following action is done in step S2 by accessing the rules 20 and/or patient information data 22. The rules 20 and patient information data 22 might be stored in different databases. Also, it is possible that these data are stored in the same one database. In this respect it is important to mention that generally all relevant information will accessed for deducing possible following actions. With other words, if necessary, also other data will accessed. For example it is possible to access guideline related data which might also provide a following action for the respective action A. Also, other databases could accessed. Patient information data 22 usually comprises all relevant information with respect to the patient, for example previous examinations, previous medications, previous diagnosis, historical anamnesis data and actual anamnesis data, insurance date and other meta information with respect to the patient.

In step S3 all deduced following actions are evaluated. The evaluation is done by applying the optimization criteria 24. Referring to the decision tree, represented in FIG. 2, ranking data is assigned to each all possible following action (represented by nodes within the tree. The ranking data refers to the result of the evaluation process. Namely, that a following action will be selected as following action, which has the best ranking data according to the optimization criteria 24.

In step S4 a result is generated. The result might comprise one optimal following action or a set of optimal following actions. In the latter case the result might comprise a first following action, which has been evaluated as being optimal and a second following action, which has been evaluated as being second optimal and so on. Thus, the physician or the clinical user gets several options and choices.

As shown in FIG. 3 deducing S2 and evaluating S3 are executed by accessing all relevant information. Particularly, the rules 20, the patient information data 22 and the optimization criteria 24 are accessed. In other embodiments it is also possible that additional databases are accessed. Further, it is possible, that only a selection of the above mentioned date is accessed.

Depending on the specific use case it is possible that deducing S2 and evaluating S3 are executed by accessing the relevant information (rules 20, patient information data 22 and optimization criteria 24). In another embodiment other optimizing criteria are to be applied so that, for example, the method might be executed more rapidly.

First all relevant data is gathered and collected, possibly from different storage places, so that input information, at least comprising rules 20, patient information data 22 and optimizing criteria 24 are combined or concentrated, preferably in one database which might be accessed during deducing S2 and/or evaluating S3. The knowledge which has been acquired during the method is fed back to the system after the suggestion in step S4 and possibly might lead to an adaption of rules 20 or of optimizing criteria 24.

An advantage of the system 10 according to the invention is that the decision for a following action within the clinical pathway will take into account optimization criteria 24 of the whole clinical pathway. This means that generally, all relevant patient information data will be explored before a following action is initiated. This means, for example that the historical anamnestic information will be explored before another blood test or another MR procedure is initiated, due to higher costs for the latter. This aspect leads to high reduction in costs. Each single decision will be based on all information which has been acquired so far and will include costs efficiency aspects.

An important application of an embodiment of the present invention is to be seen in optimizing criteria 24 which are related to availability aspects. For example, if a patient is admitted to a hospital at night and if there does not exist an acute and urgent obligation to action, a decision for an optimal following action would be another, compared to the case if the patient will be admitted to the hospital during day. At night several resources or examination methods are not available. For example, it makes no sense to collect the blood from the patient, if the blood test only might be executed several hours later. In this case the best option would be, to wait for taking the patient's blood.

Another example is to evaluate meta information with respect to the patient. For example it makes no sense to further evaluate possible pregnancy, in case the patient is male.

Often a patient is admitted with not only one single symptom S, but with a set of symptoms, which lead to a set of diagnosis. In this situation the most urgent diagnosis must be evaluated at first, which is the most actual one. For example, if a patient suffers from headache and additionally suffers from an acute heart attack it makes no sense to further investigate headache. All available resources should be spent on the treatment of the heart attack.

With respect to the decision tree, represented in FIG. 2, those decisions will be excluded, which only have a minor probability. With this aspect it is possible, to get a diagnosis as soon as possible.

Also statistical data could be used as mentioned above. A result might be used as input for to the system 10 again, so that each suggestion for a following action will be tracked, so that for all future cases a likelihood will be available.

According to another embodiment of the present invention it is possible that the suggested optimal following action might automatically be initiated. Alternatively it is possible that the suggested optimal following action might be initiated upon user interaction, e.g. a user confirmation signal.

According to another aspect the method of an embodiment of the present invention might be integrated within a clinical workflow system as optimization tool.

With respect to failure reduction it might be possible to have an inconsistency check. This inconsistency check is directed to such situations, in which the suggested optimal following action is rejected as being inconsistent with clinical knowledge. In this case a warning information signal is send to the system which could evaluated furhter. Also, it might be checked where the suggested optimal following action is inconsistent with any other data, for example with rules 20 or with patent information data 22.

Preferably, the system 10 according to an embodiment of the invention may be implemented in any suitable client server network environment such as a local area network (LAN) or a wide area network (WAN) or alternate types of internet work. Moreover, anyone of a variety of client-server architectures may be used, including but not limited to TCP/IP (HTTP network) or specifications like NAS and SAA. All modules of the system (clients and server) maybe interconnected by a bus, like an enterprise service bus (ESB). Further, there might be used a central or several data basis for storing and retrieving data related to the implementation of the process. Thus, the network may include a plurality of devices, such as server, rooters and switching circuits connecting in a network configuration, as known by a person skilled in the art.

The user of the system may use different computer devices, such as a personal computer (PC) a personal digital assistant (PDA) or other devices using wireless or wired communication protocols to access the other network modules and servers. The computer device might be coupled to I/O devices (not shown) that may include a keyboard in combination with a pointing device, such as a mouse to input data into the computer, a computer display screen and/or a printer to produce an output in a graphical representation or in paper form, storage means, resources, hard disk drives for storing and retrieving data for the computer. In respect to the architecture of the computer system it has to be mentioned that the configuration may be modified. For example, multiple redundant servers could be implemented for both faster operations and enhanced reliability. Also, additional service could be used for various alternative functions (e.g. gateway functions) within the system.

The above description of illustrated embodiments of the invention is not intended to be exhaustive or to limit the invention to precise forms disclosed. While specific embodiments of, and examples for, the invention are described herein for illustrative purposes various equivalent modifications are possible within the scope of the invention and can be made without a deviating from the spirit and scope of the invention.

Further, the method might be implemented in software, in coded form. Alternatively, it is possible to implement the method according to an embodiment of the invention in hardware or hardware modules. The hardware modules are then adapted to perform the functionality of the steps of the method. Furthermore, it is possible to have a combination of hardware and software modules.

These and other modifications can be made to an embodiment of the invention with regard of the above detailed description. The terms used in the following claims should not be construed to limit the invention to the specific embodiments disclosed in the specification and the claims. Rather, the scope of the invention is to be determined entirely by the following claims, which are to be construed in accordance with established doctrines of claim interpretation.

1. A method for optimizing a clinical pathway, including a sequence of actions, the method comprising:
providing a set of rules for deducing at least one following action;
providing patient information data;
providing a set of optimizing criteria for optimizing the clinical pathway, the optimizing criteria being pre-definable;
receiving at least one of a symptom and an initial action;
deducing, by a computer, a set of possible following actions within the clinical pathway without previously inputting a proposed clinical pathway for at least one of the received symptom and the received initial action, by at least one of applying at least one of the provided rules and applying the provided patient information data;
evaluating, by a computer, the deduced set of possible following actions by applying the provided set of optimizing criteria for deducing at least one optimal following action; and
suggesting the at least one optimal following action as a result.

2. The method according to claim 1, wherein the patient information data includes, at least one of past examination data, patient record data, patient interview data, and previous diagnostic result data.

3. The method according to claim 1, wherein the set of optimizing criteria includes at least one of availability aspects, cost aspects, helpfulness aspects, overall aspects, relating to the pathway as a whole, guideline suggestions, efficiency aspects, time aspects, and clinical path shortening aspects.

4. The method according to claim 1, wherein the result of the optimization is represented by a weighted decision tree, wherein the actions are represented by nodes of the tree, wherein results of the actions are represented by edges of the tree, and wherein diagnosis data are represented by leaf nodes.

5. The method according to claim 1, wherein the result includes a set of following actions.

6. The method according to claim 1, wherein the result is at least one of provided and transformed in a machine readable format, and is forwardable to other computer implemented modules.

7. A system for optimizing a clinical pathway, including a sequence of actions, the system comprising:
a computer storing,
a reception unit to receive at least one of a symptom and an initial action;
a deduction unit to deduce a set of possible following actions within a clinical pathway without previously inputting a proposed clinical pathway for the at least one received symptom and the received initial action, where at least one of the deduction unit is linked to and accesses a rule database which provides rules for deducing a respective following action and the deduction unit is linked to and accesses a patient information database for providing patient information data;
an evaluation unit, where the evaluation unit is linked to and accesses an optimization unit, the optimization unit being adapted for providing optimization criteria for optimizing the clinical pathway, so that the deduced following actions are evaluated; and
a result unit, adapted to suggest the optimal following action as a result.

8. The system according to claim 7, wherein the system includes, at least one of a rule database, a patient information database, and an optimization unit.

9. A computer readable medium having computer-executable instructions for executing a method, when the computer readable medium is loaded on to a computer, wherein the method is adapted for optimizing a clinical pathway, including a sequence of actions, the method comprising:
providing a set of rules for deducing at least one following action;
providing patient information data;
providing a set of optimizing criteria for optimizing the clinical pathway, the optimizing criteria being pre-definable;
receiving at least one of a symptom and an initial action;
deducing a set of possible following actions within the clinical pathway without previously inputting a proposed clinical pathway for at least one of the received symptom and the received initial action, by applying at least one of at least one of the provided rules and the provided patient information data;
evaluating the deduced set of possible following actions by applying the provided set of optimizing criteria for deducing at least one optimal following action; and
suggesting the at least one optimal following action as a result.

10. (canceled)

11. The method according to claim 1, wherein the clinical pathway includes clinical decisions within at least one of a diagnosis and a therapy.

12. The method according to claim 1, wherein the sequence of actions account for previous and future actions.
